(19) United States
(12) Patent Application Publication
(10) Pub. No.: US 2026/0104984 A1
(43) Pub. Date: Apr. 16, 2026

(54) SOFTWARE BREAKPOINT FOR SHARED CODE REGIONS IN A MULTI-PROCESSOR ARCHITECTURE

(71) Applicant: QUALCOMM Incorporated, San Diego, CA (US)

(72) Inventors: Amey MAHAJAN, San Diego, CA (US); Jeremy GILBERT, San Diego, CA (US); Richard SENIOR, San Diego, CA (US); Jing LIU, San Diego, CA (US)

(21) Appl. No.: 18/916,511

(22) Filed: Oct. 15, 2024

(51) Int. Cl. G06F 11/36

(52) U.S. Cl. CPC G06F 11/364

(57) ABSTRACT

Aspects of the disclosure are directed to software breakpoint insertion in shared code regions. In accordance with one aspect, the disclosure includes setting a new instruction to a trap instruction in a local cache memory using a software breakpoint; locking a cache line in the local cache memory to generate a locked cache line; writing the trap instruction to a memory location specified by the locked cache line; and fetching the trap instruction from the local cache memory to start a diagnostic process.

### TECHNICAL FIELD

This disclosure relates generally to the field of information processing systems, and, in particular, to supporting software breakpoint insertion in shared code regions for a multi-processor architecture.

### BACKGROUND

An information processing system, for example, a computing platform, includes a diagnostic capability using a software debugging tool. The software debugging tool may employ a software breakpoint to insert a trap instruction for diagnostic purposes. However, in a multi-processor environment, the trap insertion may cause a conflict. A mitigation for this software breakpoint insertion conflict in the multi-processor environment is needed.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides software breakpoint insertion in shared code regions. Accordingly, the present disclosure discloses a method including: backing up the original instruction by a managerial process; setting a new instruction to a trap instruction in a local cache memory using a software breakpoint; locking a cache line in the local cache memory to generate a locked cache line or to prevent eviction; writing the trap instruction to a memory location specified by the locked cache line; and fetching the trap instruction from the local cache memory to start a diagnostic process.

In one example, the software breakpoint transfers control from an executing application process to a managerial process. In one example, the managerial process is an operating system for a selected processing engine. In one example, the diagnostic process transfers control to a software debugger in the operating system. In one example, the diagnostic process suspends the executing application process. In one example, the diagnostic process is initiated by a diagnostic utility such as a low level debugger (LLDB) on a host computer or a software kernel.

In one example, the method further includes writing an original instruction back to the memory location specified by the locked cache line. In one example, the locked cache line prevents one or more memory contents of the local cache memory from being flushed out to a common memory. In one example, the method further includes invalidating and/or unlocking the locked cache line to regenerate the cache line. In one example, the method further includes transferring control back to an executing application process in a selected processing engine. In one example, the local cache memory is dedicated to the selected processing engine.

In one example, the method further includes backing up the original instruction of the executing application process in the local cache memory specified by a virtual address. In one example, the method further includes executing the original instruction in the selected processing engine. In one example, the locked cache line is specified by the virtual address.

Another aspect of the disclosure provides an apparatus including: a cache memory configured to store an original instruction, wherein the original instruction is specified by a virtual address; and a core processing engine coupled to the cache memory, the core processing engine configured to lock a cache line in the cache memory to generate a locked cache line.

In one example, the core processing engine is further configured to write the original instruction back to a memory location specified by the locked cache line. In one example, the core processing engine is further configured to unlock the locked cache line to regenerate the cache line.

Another aspect of the disclosure provides an apparatus including: means for setting a new instruction to a trap instruction in a local cache memory using a software breakpoint; means for locking a cache line in the local cache memory to generate a locked cache line; means for writing the trap instruction to a memory location specified by the locked cache line; and means for fetching the trap instruction from the local cache memory to start a diagnostic process.

In one example, the apparatus further includes: means for writing an original instruction back to the memory location specified by the locked cache line; and means for unlocking the locked cache line to regenerate the cache line. In one example, the apparatus further includes: means for transferring control back to an executing application process in a selected processing engine; and means for backing up the original instruction of the executing application process in the local cache memory specified by a virtual address.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example multi-processor system.

FIG. 3 illustrates an example pseudocode for a set breakpoint instruction sequence.

FIG. 4 illustrates an example pseudocode for a delete breakpoint instruction sequence.

FIG. 5 illustrates an example flow diagram 500 for implementing software breakpoint insertion in shared code regions.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

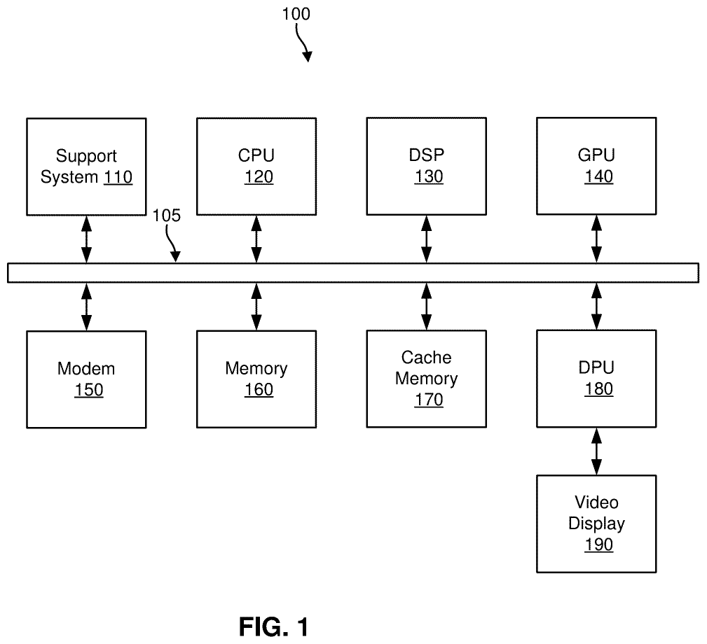

FIG. 1 illustrates an example information processing system 100. In one example, the information processing system 100 includes a plurality of processing engines, or processor cores, such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines.

In one example, a software debugging capability implements a software breakpoint by substituting a trap instruction for an original instruction in a sequence of instructions (i.e., instruction code). In one example, the trap instruction transfers control from an executing application process to a managerial process (e.g., operating system). In one example, the original instruction is saved in a memory for later restoral.

In one example, upon execution of the trap instruction, a software kernel is initiated which suspends the executing application process (e.g., software thread) and control is transferred to a software debugger in the operating system. In one example, a software kernel is a fundamental element of an operating system. In one example, when the software debugger completes execution of the trap instruction, the executing application process is restarted with the original instruction and the trap instruction may be reinserted as the software breakpoint. In one example, the software debugger is a diagnostic tool for debugging an executing application process.

In one example, a first scenario includes a multi-processor system with a common memory shared by all processors in the system. For example, each processor of the multi-processor system may execute a same image (i.e., copy) of instruction code. In one example, if one processor in the multi-processor system sets a software breakpoint in the common memory, all processors observe the software breakpoint.

In one example, a second scenario includes a compressed memory system. In one example, if a common memory includes compressed data (i.e., data encoded into a more compact form), a software debugger needs to comprehend a compression scheme used to generate the compressed data. In one example, the software debugger needs to execute atomic updates to the compressed data in the common memory. For example, presence of compressed data in the common memory may present a significant technical challenge.

In one example, a third scenario includes a read only memory (ROM). For example, software breakpoints cannot be set when instruction code is stored in the ROM (i.e., since ROM cannot be over-written). For example, on-chip hardware breakpoints could be used, but with significant limitations.

In one example, a localized software breakpoint methodology may be used for a software debugging capability. In one example, the localized software breakpoint methodology locks a specific cache memory line, where a trap instruction is to be placed, into a local cache memory of a given processor of a plurality of processors. In one example, locking a specific cache memory line prevents memory contents of the specific cache memory line from being flushed out to a common memory. For example, since each processor of the plurality of processors localizes the software breakpoint into its local cache memory, conflicts are prevented in the plurality of processors.

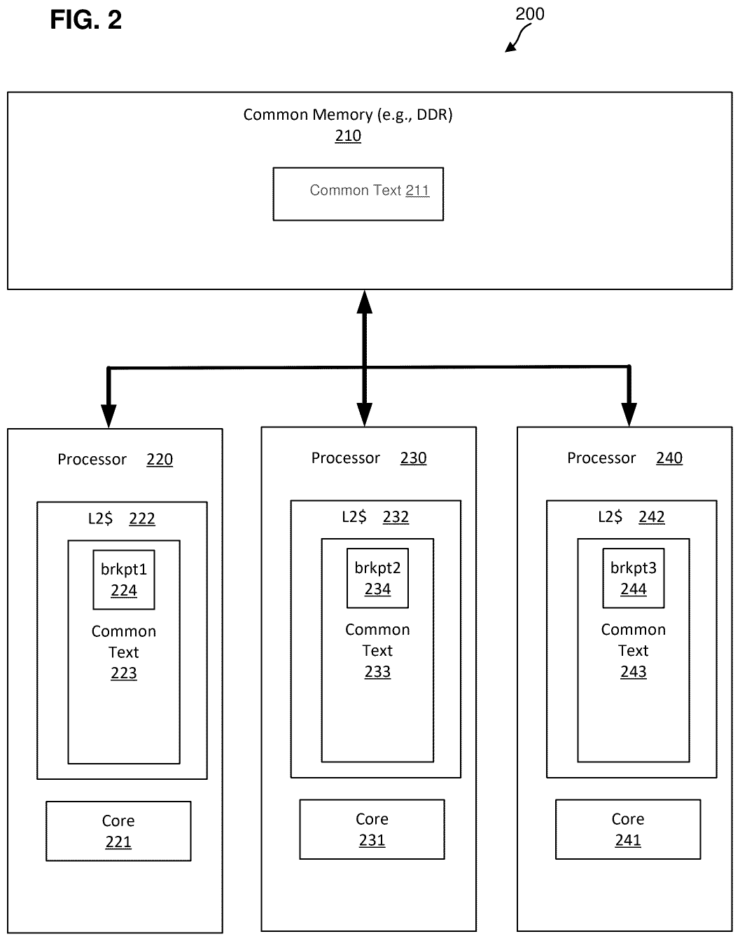

FIG. 2 illustrates an example multi-processor system 200. In one example, the example multi-processor system 200 includes a common memory 210 (e.g., a double data rate (DDR) memory). For example, the common memory 210 stores a common text 211. In one example, the common text 211 is a sequence of instructions.

In one example, the multi-processor system 200 includes a plurality of processors including a first processor 220, a second processor 230, and so on until a nth processor 240. In one example, each processor of the plurality of processors has a dedicated local cache memory.

In one example, the first processor 220 includes a first core processing engine 221 to execute instruction code. In one example, the first processor 220 includes a first cache memory 222 (e.g., a second level (L2) cache memory). In one example, the first cache memory 222 stores a first copy of the common text 223 which is identical to the common text 211. In one example, the first copy of the common text 223 includes a first software breakpoint 224. For example, the first software breakpoint 224 substitutes a first trap instruction for a first original instruction in a first sequence of instructions.

In one example, the second processor 230 includes a second core processing engine 231 to execute instruction code. In one example, the second processor 230 includes a second cache memory 232 (e.g., a second level (L2) cache memory). In one example, the second cache memory 232 stores a second copy of the common text 233 which is identical to the common text 211. In one example, the second copy of the common text 233 includes a second software breakpoint 234. For example, the second software breakpoint 234 substitutes a second trap instruction for a second original instruction in a second sequence of instructions.

In one example, the nth processor 240 (a.k.a. third processor shown in the example of FIG. 2) includes a third core processing engine 241 to execute instruction code. In one example, the nth processor 240 includes a third cache memory 242 (e.g., a second level (L2) cache memory). In one example, the third cache memory 242 stores a third copy of the common text 243 which is identical to the common text 211. In one example, the third copy of the common text 243 includes a third software breakpoint 244. For example, the third software breakpoint 244 substitutes a third trap instruction for a third original instruction in a third sequence of instructions. One skilled in the art would understand that the quantity of processors is not limited to three processors as shown in FIG. 2 and that other quantities are also within the scope and spirit of the present disclosure.

In one example, the localized software breakpoint methodology enables the example multi-processor system 200 to set a large quantity of software breakpoints compared to hardware breakpoints with no memory overhead. In one example, localized software breakpoints allow a software breakpoint to be supported in a multi-processor system with a shared memory architecture, a compressed memory architecture or a ROM-based architecture.

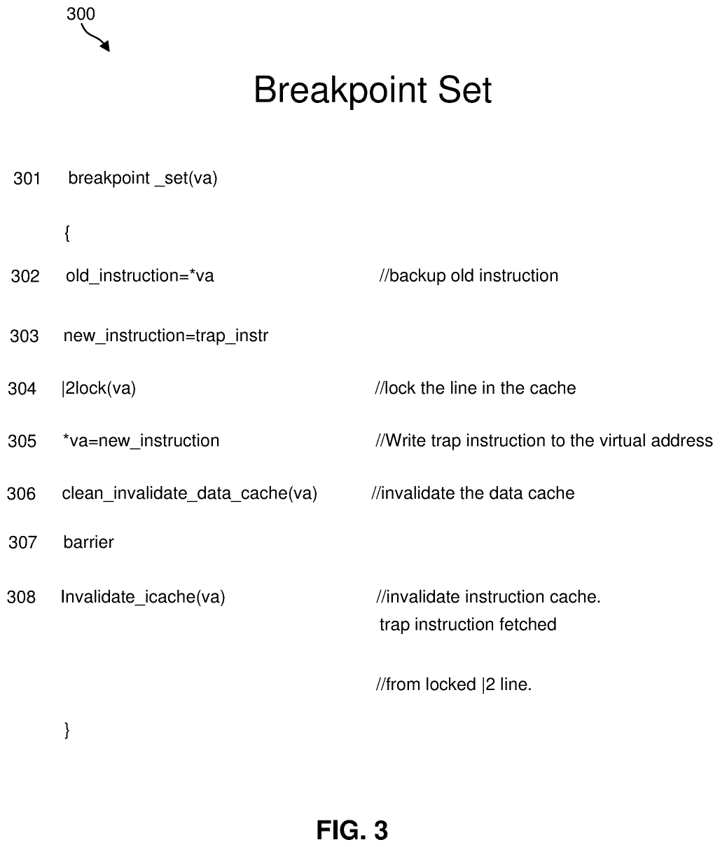

FIG. 3 illustrates an example pseudocode for a set breakpoint instruction sequence 300. In one example, the set breakpoint instruction sequence 300 starts with a breakpoint_set(va) function call 301. In one example, the first instruction 302 backs up an original instruction (a.k.a., old instruction) specified by a virtual address VA. In one example, the second instruction 303 sets a new instruction to a trap instruction. In one example, the third instruction 304 locks a cache line in a local cache memory at the virtual address VA. In one example, the fourth instruction 305 writes the new instruction to the virtual address VA. In one example, the fifth instruction 306 invalidates the local cache memory. In one example, the sixth instruction 307 is a barrier instruction (i.e., an instruction that forces completion of all instructions prior to the barrier instruction). In one example, the seventh instruction 308 is an invalidate instruction cache instruction at the virtual address VA. In one example, execution of the invalidate instruction forces a fetch of the trap instruction from the locked cache line in the local cache memory.

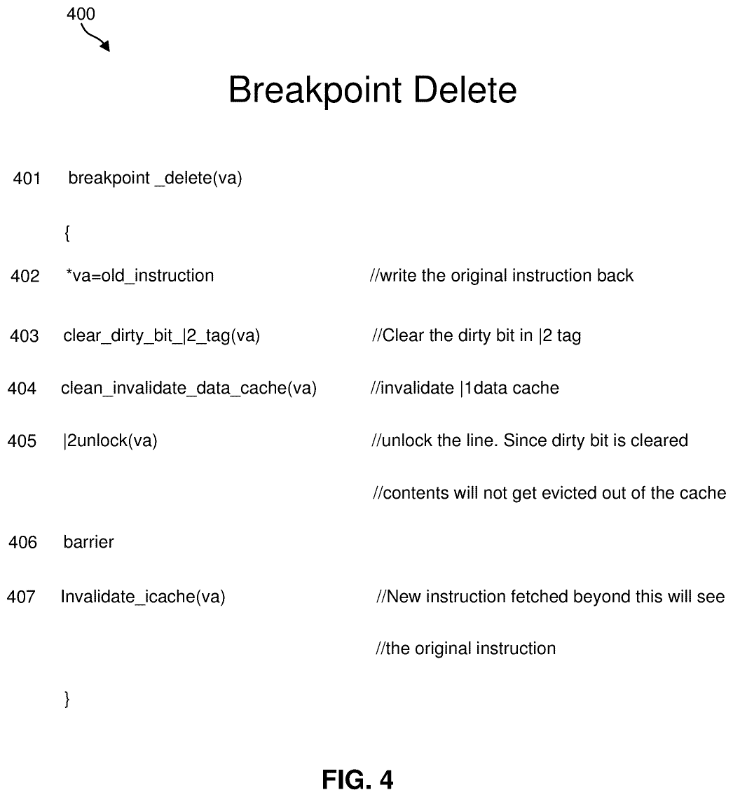

FIG. 4 illustrates an example pseudocode for a delete breakpoint instruction sequence 400. In one example, the delete breakpoint instruction sequence 400 starts with a breakpoint_delete(va) function call 401. In one example, the first instruction 402 writes back the original instruction to a memory location specified by the virtual address VA. In one example, the second instruction 403 clears a dirty bit in a cache memory tag. In one example, the third instruction 404 is an invalidate instruction cache instruction at the virtual address VA. In one example, the fourth instruction 405 unlocks a cache line in a local cache memory at the virtual address VA. In one example, the fifth instruction 406 is a barrier instruction (i.e., an instruction that forces completion of all instructions prior to the barrier instruction). In one example, the sixth instruction 407 is an invalidate instruction cache instruction at the virtual address VA. In one example, execution of the invalidate instruction fetches the original instruction for a new instruction.

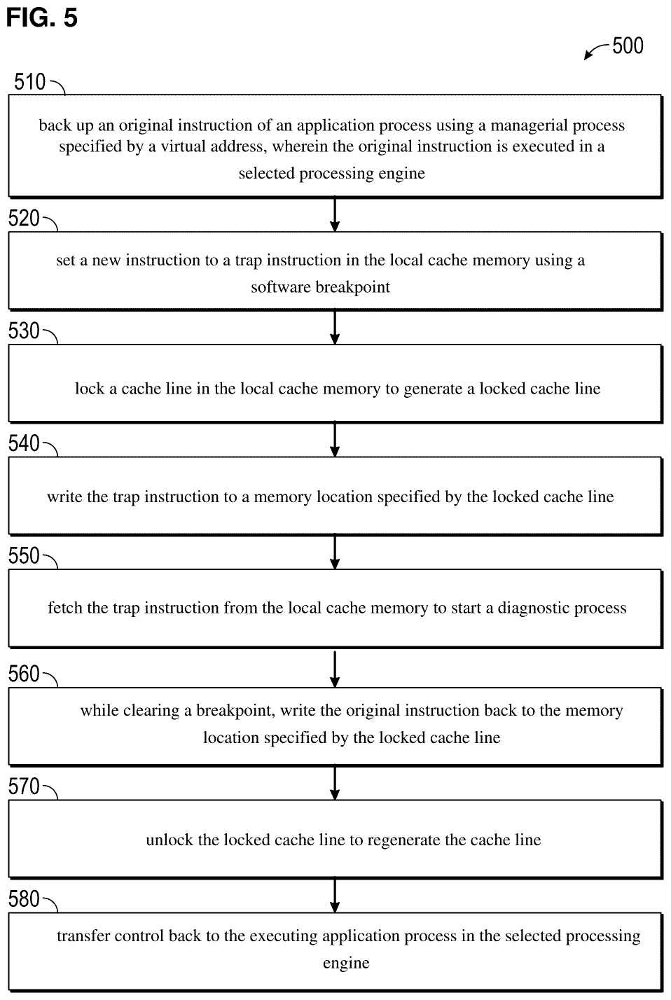

FIG. 5 illustrates an example flow diagram 500 a for implementing software breakpoint insertion in shared code regions. In block 510, back up an original instruction of an application process using a managerial process specified by a virtual address, wherein the original instruction is executed in a selected processing engine. In one example, an original instruction of an executing application process is backed up using the managerial process specified by a virtual address. In one example, the original instruction is part of an executing application process. In one example, the original instruction is executed on a selected processing engine. In one example, the local cache memory is dedicated to the selected processing engine. In one example, the selected processing engine is part of a plurality of processing engines each with dedicated local cache memory. In one example, the step of block 510 is performed by a core processing engine, a microprocessor, microcontroller, a CPU, a GPU, a DPU.

In block 520, set a new instruction to a trap instruction in the local cache memory using a software breakpoint. In one example, a new instruction is set to a trap instruction in the local cache memory using a software breakpoint. In one example, the software breakpoint transfers control from an executing application process to a managerial process. In one example, the managerial process is an operating system for the selected processing engine. In one example, the step of block 520 is performed by a core processing engine, a microprocessor, microcontroller, a CPU, a GPU, a DPU.

In block 530, lock a cache line in the local cache memory to generate a locked cache line. In one example, a cache line is locked in the local cache memory to generate a locked cache line. In one example, the cache line is specified by the virtual address. In one example, locking the cache line prevents memory contents of the local cache memory line from being flushed out to a common memory. In one example, the step of block 530 is performed by a cache memory, a level 2 (L2) cache memory, a level 1 (L1) cache memory, a static random access memory (RAM), a dynamic random access memory (RAM).

In block 540, write the trap instruction to a memory location specified by the locked cache line. In one example, the trap instruction is written to a memory location specified by the locked cache line. In one example, the locked cache line is specified by the virtual address. In one example, the writing of the trap instruction is independent of the execution of other processing engine. In one example, the step of block 540 is performed by a core processing engine, a microprocessor, microcontroller, a CPU, a GPU, a DPU.

In block 550, fetch the trap instruction from the local cache memory to start a diagnostic process. In one example, the trap instruction is fetched from the local cache memory to start a diagnostic process. In one example, the instruction cache is part of the local cache memory. In one example, the diagnostic process is initiated by a software kernel. In one example, the diagnostic process suspends the executing application process (e.g., software thread). In one example, the diagnostic process transfers control to a software debugger in the operating system. In one example, the step of block 550 is performed by a core processing engine, a microprocessor, microcontroller, a CPU, a GPU, a DPU.

In block 560, while clearing a breakpoint, write the original instruction back to the memory location specified by the locked cache line. In one example, the original instruction is written back to the memory location specified by the locked cache line. In one example, the locked cache line is specified by the virtual address. In one example, the step of block 560 is performed by a core processing engine, a microprocessor, microcontroller, a CPU, a GPU, a DPU.

In block 570, unlock the locked cache line to regenerate the cache line. In one example, the locked cache line is unlocked to regenerate the cache line. In one example, the locked cache line prevents data eviction from the local cache memory. In one example, the step of block 570 is performed by a cache memory, a level 2 (L2) cache memory, a level 1 (L1) cache memory, a static random access memory (RAM), a dynamic random access memory (RAM).

In block 580, transfer control back to the executing application process in the selected processing engine. In one example, control is transferred back to the executing application process in the selected processing engine. In one example, the executing application process continues with the original instruction in the selected processing engine. In one example, the step of block 580 is performed by a core processing engine, a microprocessor, microcontroller, a CPU, a GPU, a DPU.

In one aspect, one or more of the steps for providing software breakpoint insertion in shared code regions in FIG. 5 may be executed by one or more processors which may include hardware, software, firmware, etc. The one or more processors, for example, may be used to execute software or firmware needed to perform the steps in the flow diagram of FIG. 5. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method comprising:
setting a new instruction to a trap instruction in a local cache memory using a software breakpoint;
locking a cache line in the local cache memory to generate a locked cache line;
writing the trap instruction to a memory location specified by the locked cache line; and
fetching the trap instruction from the local cache memory to start a diagnostic process.

2. The method of claim 1, wherein the software breakpoint transfers control from an executing application process to a managerial process.

3. The method of claim 2, wherein the managerial process is an operating system for a selected processing engine.

4. The method of claim 3, wherein the diagnostic process transfers control to a software debugger in the operating system.

5. The method of claim 2, wherein the diagnostic process suspends the executing application process.

6. The method of claim 1, wherein the diagnostic process is initiated by a software kernel.

7. The method of claim 1, further comprising writing an original instruction back to the memory location specified by the locked cache line.

8. The method of claim 7, wherein the locked cache line prevents one or more memory contents of the local cache memory from being flushed out to a common memory.

9. The method of claim 7, further comprising unlocking the locked cache line to regenerate the cache line.

10. The method of claim 9, further comprising transferring control back to an executing application process in a selected processing engine.

11. The method of claim 10, wherein the local cache memory is dedicated to the selected processing engine.

12. The method of claim 10, further comprising backing up the original instruction of the executing application process in the local cache memory specified by a virtual address.

13. The method of claim 12, further comprising executing the original instruction in the selected processing engine.

14. The method of claim 13, wherein the locked cache line is specified by the virtual address.

15. An apparatus comprising:
a cache memory configured to store an original instruction, wherein the original instruction is specified by a virtual address; and
a core processing engine coupled to the cache memory, the core processing engine configured to lock a cache line in the cache memory to generate a locked cache line.

16. The apparatus of claim 15, wherein the core processing engine is further configured to write the original instruction back to a memory location specified by the locked cache line.

17. The apparatus of claim 16, wherein the core processing engine is further configured to unlock the locked cache line to regenerate the cache line.

18. An apparatus comprising:
means for setting a new instruction to a trap instruction in a local cache memory using a software breakpoint;
means for locking a cache line in the local cache memory to generate a locked cache line;
means for writing the trap instruction to a memory location specified by the locked cache line; and
means for fetching the trap instruction from the local cache memory to start a diagnostic process.

19. The apparatus of claim 18, further comprising:
means for writing an original instruction back to the memory location specified by the locked cache line; and
means for unlocking the locked cache line to regenerate the cache line.

20. The apparatus of claim 19, further comprising:
means for transferring control back to an executing application process in a selected processing engine; and
means for backing up the original instruction of the executing application process in the local cache memory specified by a virtual address.
